(19) United States
(12) Patent Application Publication
(10) Pub. No.: US 2006/0119114 A1
(43) Pub. Date: Jun. 8, 2006

(54) Inside door element for a motor vehicle comprising a cover used as a break-in prevention device

(76) Inventors: Thomas Kreitz, Solingen (DE); Pedro Almeida, Osnabruck (DE)

Correspondence Address: WILLIAM COLLARD;COLLARD & ROE, P.C., 1077 NORTHERN BOULEVARD, ROSLYN, NY, 11576, US

(21) Appl. No.: 10/542,275

(22) PCT Filed: Jul. 28, 2004
(86) PCT No.: PCT/EP04/08428

§ 371 Date: Jul. 14, 2005

(30) Foreign Application Priority Data
Nov. 14, 2003 (DE) 203 17 709.6

(51) Int. Cl. E05B 17/00; B60J 5/04

(52) U.S. Cl. 292/346; 49/502

(57) ABSTRACT

The invention relates to a door inner element (1) made of plastic for a motor vehicle door which has a windowpane that can be raised and lowered, having an outer side, an inner side, an opening (3), leading from the inner side to the outer side, for passing through a force transmission element (4), used to actuate a door lock, in the form of a Bowden cable or an actuating rod. In order to prevent unauthorized unlocking of the door lock from the outside using a manipulation tool, a cover (9) is assigned to the force transmission element (4) as a break-in safeguard. The cover (9) is molded in one piece onto the outer side of the door inner element (1). The single FIGURE is intended for the abstract.

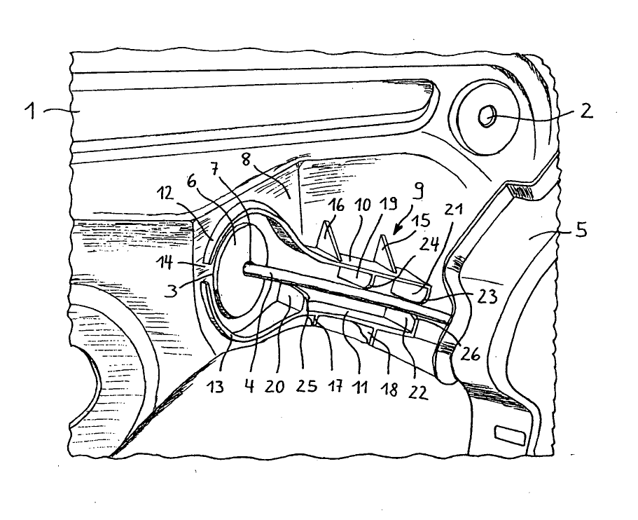

The invention relates to a door inner element made of plastic for a motor vehicle door which has a windowpane that can be raised and lowered, having an outer side, an inner side, an opening, leading from the inner side to the outer side, for passing through a force transmission element, used to actuate a door lock, in the form of a Bowden cable or an actuating rod, and a cover, assigned to the force transmission element, as a break-in safeguard against unauthorized unlocking of the door lock from the outside using a manipulation tool.

The door inner element essentially consists of plastic and has an opening leading from its inner side to the outer side for passing through a force transmission element, used to actuate a door lock, in the form of a Bowden cable or an actuating rod.

In order to prevent unauthorized unlocking of the vehicle door from the outside using a manipulation tool, securing the Bowden cable or the actuating rod by an appropriate cover is known in principle.

Break-in safeguards for motor vehicle doors of this type are described, for example, in DE 35 30 861 A1 and DE 44 34 307 C2. The covers known from these publications are implemented as separate parts and have the form of an angled element or tube which is attached to a door section, particularly an inner wall of the door panel.

The present invention is based on the object of securing a Bowden cable for actuating a motor vehicle door lock or a corresponding actuating rod, which is coupled to an interior door handle or a locking device positioned on the inside of the door, in an effective and cost-effective way against access by manipulation tools, which are introduced from the outside between the windowpane and the outer window seal into the door cavity to unlock the vehicle door.

This object is achieved according to the present invention in that the cover assigned to the force transmission element is molded in one piece onto the outer side of the interior door element. The molding in one piece may particularly be performed as the door inner element is manufactured in the injection molding method. However, performing the molding of the cover onto the door inner element in one piece in the injection compression or embossing methods also lies within the scope of the present invention.

The door inner element according to the present invention effectively prevents with its integrated cover unauthorized unlocking of the vehicle door through manipulation tools, which are introduced from the outside between the windowpane and the outer window seal into the vehicle door to engage the Bowden cable or a corresponding actuating rod. The molding of the cover in one piece onto the door inner element, which is manufactured from plastic, preferably in the injection molding method, results in a reduction of the components to be mounted and therefore to a savings in work time and a corresponding reduction in cost.

An advantageous embodiment of the solution of the object according to the present invention is characterized in that the cover is formed by two web-shaped cover sections that are spaced apart from one another, which project essentially perpendicularly from the outer side of the door inner element, transverse ribs, which end at a distance to the particular diametrically opposing web-shaped cover section, being molded onto sides of the web-shaped cover sections facing toward one another, so that a channel defined by the web-shaped cover sections for receiving the force transmission element is constricted by the transverse ribs.

If a Bowden cable is used as the force transmission element, this embodiment allows a tolerance compensation during mounting of the Bowden cable. The spacing of the web-shaped cover sections may be selected as sufficiently large for a tolerance compensation in this embodiment and the Bowden cable may be laid—if necessary—with a slight meander in the channel defined by the web-shaped cover sections, the transverse ribs representing an effective obstruction for a manipulation tool introduced into the door to engage the Bowden cable.

In this embodiment of the cover, it is especially favorable if at least one transverse rib of one web-shaped cover section is positioned offset to at least one transverse rib of the other web-shaped cover section.

Further preferred and advantageous embodiments of the present invention are specified in the subclaims.

In the following, the present invention will be explained in greater detail on the basis of a drawing showing an exemplary embodiment. The single FIGURE shows a perspective illustration of a section of the outer side of an door inner element 1 according to the present invention, which has multiple openings 2 or holes for attachment to an door inner panel (not shown) of a motor vehicle door.

The door inner element 1 is an aggregate support, which is used for holding different functional components of the motor vehicle door, such as a window lifter, a door lock, a side airbag, an energy absorption device for protecting a vehicle occupant in the event of a side impact, and/or loudspeakers.

The door inner element 1 has an opening 3 for passing through a force transmission element 4 in the form of a Bowden cable guided in a Bowden sleeve. The Bowden cable 4 leads from a door lock (not shown) positioned outside the door inner element 1 to a lock actuation device, such as an interior door handle, positioned in an interior door paneling (not shown). A section of a cover 5 that protects the door lock from moisture and/or manipulation is shown in the drawing.

The door inner element 1 is made, at least in the region of the opening 3 for passing through the force transmission element 4, from plastic, preferably from fiberglass-reinforced plastic, such as fiberglass-reinforced polypropylene. A plastic manufactured in the injection molding foam method is especially preferable. A foamed door inner element of this type has a sound-insulating effect and has a relatively high strength at low weight. The door inner element 1 manufactured in the injection molding foam method (also called thermoplastic foam casting) has a compact external skin and a cellular core.

An annular, rubber-elastic seal 6, which has a passage 7 for passing through the Bowden cable 4, is inserted into the opening 3. The opening 3 is implemented in a section 8 of the door inner element 1 that runs diagonally or transversely to the main plane of the door inner element 1. A cover 9 is molded on in one piece in the region around opening 3 or seal 6 and in the direction of the door lock, which is used as a break-in safeguard against authorized unlocking of the door lock using a manipulation tool, which is possibly introduced from the outside between the windowpane and the outer window seal into the vehicle door to engage the Bowden cable 4.

The cover 9 molded from the same material onto the door inner element 1 is implemented in the form of an open channel running in the longitudinal direction of the Bowden cable 4. It is formed by two web-shaped cover sections 10, 11 at a distance to one another, which project essentially perpendicularly from the outer side of the door inner element 1. The cover particularly has two curved cover sections 12, 13, which enclose the opening 3 or annular seal 6. The two curved cover sections 12, 13 are separated from one another at their ends by a recess 14. The height of the cover sections 10, 11, 12, 13 is dimensioned in such a way that they project over the mounted Bowden cable 4 by a specific amount, preferably at least 5 mm, particularly at least 10 mm.

Stiffening ribs 15, 16, 17, 18 are positioned on the outer sides of the web-shaped cover sections 10, 11. The upper stiffening ribs 15, 16 have a triangular shape having an edge running diagonally from the upper edge of the web-shaped cover section 10 to the outer side of the door inner element 1, while the lower stiffening ribs 17, 18 adjoin the curved contour of a projection of the door inner element 1 and have an edge running essentially at the height of the upper edge of the web-shaped cover section 11.

Transverse ribs 19, 20, which end at a distance in front of the particular diametrically opposite web-shaped cover section 10 or 11, respectively, are molded onto the sides of the web-shaped cover sections 10, 11 facing toward one another. The distance approximately corresponds to the dimension which results from the sum of the diameter of the Bowden cable 4 and the extension of the nearest transverse rib 19 or 20, respectively, to the diametrically opposing web-shaped cover section 10 or 11 in the direction of the Bowden cable 4.

The transverse ribs 21, 22, which are implemented on the ends of the cover sections 10, 11 facing toward one another, lie essentially aligned opposite one another. Their spacing approximately corresponds to the diameter of the Bowden cable 4. In contrast, the transverse rib 19 of the upper cover section 10 is positioned offset to the transverse rib 20 of the lower cover section 11, i.e., the transverse ribs 19 and 20 are not aligned with one another. The transverse ribs 19, 20, 21, and 22 each terminate flush with the edge of the cover sections 10, 11 facing toward the door external skin and each have rounded outer corners 23, 24, 25, and 26, respectively.

The implementation of the invention is not restricted to the exemplary embodiment described above. Rather, multiple variations are possible, which make use of the inventive idea defined in the claims even in the event of significantly deviating design. Thus, for example, the cover 9 according to the present invention may also have more transverse ribs than the cover shown in the attached drawing. Furthermore, the force transmission element 4 may also possibly be an actuating rod.

1. A door inner element (1) made of plastic for a motor vehicle door which has a windowpane that may be raised and lowered, having an outer side, an inner side, an opening (3), leading from the inner side to the outer side, for passing through a force transmission element (4), used to actuate a door lock, in the form of a Bowden cable or an actuating rod and a cover (9), assigned to the force transmission element (4), as a break-in safeguard against unauthorized unlocking of the door lock from the outside using a manipulation tool, wherein the cover (9) is molded in one piece onto the outer side of the door inner element (1).

2. The door inner element according to claim 1, wherein the cover (9) is implemented in the form of an open channel running in the longitudinal direction of the force transmission element (4).

3. The door inner element according to claim 1, wherein the cover (9) is formed by at least two web-shaped cover sections (10, 11), which are spaced apart from one another, that project essentially perpendicularly from the outer side of the interior door element (1).

4. The door inner element according to claim 1, wherein the cover (9) has stiffening ribs (15, 16, 17, 18).

5. The door inner element according to claim 3, wherein the stiffening ribs (15, 16, 17, 18) are positioned on the outer sides of the web-shaped cover sections (10, 11).

6. The door inner element according to claim 3, wherein transverse ribs (19, 20, 21, 22), which end at a distance to the particular diametrically opposing web-shaped cover section (10 or 11, respectively), are molded onto the sides of the web-shaped cover sections (10, 11) facing toward one another, so that a channel defined by the web-shaped cover sections is constricted by the transverse ribs (19, 20, 21, 22) to receive the force transmission element (4).

7. The door inner element according to claim 6, wherein the transverse ribs (19, 20, 21, 22) terminate flush with an edge of the cover sections (10, 11) that points toward the external skin of the vehicle door.

8. The door inner element according to claim 6, wherein the transverse ribs (19, 20, 21, 22) have rounded external corners (23, 24, 25, 26).

9. The door inner element according to claim 6, wherein at least one transverse rib (19) of one web-shaped cover section (10) is positioned offset to at least one transverse rib (20) of the other web-shaped cover section (11).

10. The door inner element according to claim 1, wherein the cover (9) has at least two curved cover sections (12, 13), which enclose the opening (3) for passing through the force transmission element (4).
